(19) United States
(12) Patent Application Publication
(10) Pub. No.: US 2007/0210207 A1
(43) Pub. Date: Sep. 13, 2007

(54) FLYING WING ROTATION MECHANISM OF MICRO AIR VEHICLE

(76) Inventor: Wei-Hsiang LIAO, Hsinchu City (TW)

Correspondence Address: RABIN & Berdo, PC, 1101 14TH STREET, NW, SUITE 500, WASHINGTON, DC, 20005, US

(21) Appl. No.: 11/748,635

(22) Filed: May 15, 2007

Related U.S. Application Data
(63) Continuation-in-part of application No. 11/367,377, filed on Mar. 6, 2006.

(51) Int. Cl. B64C 33/00

(52) U.S. Cl. 244/22

(57) ABSTRACT

A flying wing rotation mechanism of a micro air vehicle is driven under a control of a power module and a detent member. The flying wing rotation mechanism of a micro air vehicle includes a flapping arm and a flying wing. The flapping arm is connected to the detent member, and swings as the power module drives the detent member. An end of the flying wing is pivoted to the flapping arm. When the flapping arm swings, the flying wing swings with the flapping arm in sync. When swing direction of the flapping arm changes, the flying wing rotates relative to an axial direction of the flapping arm.

### CROSS-REFERENCE TO RELATED APPLICATIONS

This application is a continuation-in-part patent application of U.S. application Ser. No. 11/367,377 filed on Mar. 6, 2006, the entire contents of which are hereby incorporated by reference for which priority is claimed under 35 U.S.C. § 120.

### BACKGROUND OF THE INVENTION

1. Field of Invention

The present invention relates to a micro air vehicle, and more particularly to a flying wing rotation mechanism of a micro air vehicle.

2. Related Art

Flying motions of insects imply profound knowledge.

Taking common drosophila as an example, the flying motions of the drosophila include rapid taking off, circling, diving, and sharp turning etc. These excellent flying skills enable the drosophila to attack and get food easily, and to escape from people at the same time.

How can the drosophila do this? The thin wings of insects are distinctively different from big wings of birds. Experts in zoology, aviation, fluid dynamics are always interested in natural creatures, especially in the flying motions of insects. However, they have not yet been completely and fully realized.

The difficulties lie in that it is difficult for people to precisely describe airflow activities in 3D space, especially the airflow phenomena around the wings of the insects. The wings of the insects are very small, flutter rapidly, and are very complicated.

Early scientists researched the mechanism of the flying of the insects through analysis (steady aerodynamics) and computation (Navier-Stokes equations). However, the above two approaches cannot explain the motion that an insect takes off or hangs in the air, and cannot depict the flying of the insects completely. In the 1980s, researchers started to quantify the motion modes of the insects by means of direct measurement, and thus gradually unveiled the mysterious flying motions of the insects.

The principles of the flying of the insects have been discussed in many papers so far, and are known to people preliminarily. Generally speaking, when the swing direction and angle of the wings are different, a certain lift will be generated. Scientists have discovered many air flowing phenomena from the flying of the insects, such as leading-edge vortex, delayed stall, rotation lift, and wake capture, and some of which have been applied now.

Though scientists have developed many principles, it is still hard to produce micro air vehicles. As far as actual applications are concerned, there are still many technical problems left unsolved. Based on the known principles of air flowing, US Patent Publication No. 20040155145 discloses such an air vehicle. According to this invention, a cam having a first stopper and a second stopper is connected to an end of a wing, and is forced to rotate by using a driver to drive a driving disk, so as to drive the cam and the wing to move to fly. Further, US Patent Publication No. 6,540,177 discloses a flying object that uses actuations of a plurality of connecting rods to simulate the flying motions of a dragonfly. US Patent Publication No. 6,530,540 discloses a flying device that carries humans.

Though the above patents or conventional flying vehicles can be operated and have certain effects, these devices are hard to be implemented, or have too complex structures and high costs to be miniaturized. Therefore, these devices still have defects.

### SUMMARY OF THE INVENTION

Accordingly, the present invention discloses a flying wing rotation mechanism of a micro air vehicle, which has the advantages of simple structure and easy miniaturization.

A flying wing rotation mechanism of a micro air vehicle according to the disclosure of the present invention is driven under the control of a power module and a detent member. The flying wing rotation mechanism of a micro air vehicle includes a flapping arm and a flying wing. The flapping arm is connected to the detent member, and swings as the power module drives the detent member. An end of the flying wing is pivoted to the flapping arm. When the flapping arm swings, the flying wing swings with the flapping arm in sync. When a swing direction of the flapping arm changes, the flying wing rotates relatively to an axial direction of the flapping arm.

In order to make the aforementioned and other objects, features and advantages of the present invention comprehensible, a preferred embodiment accompanied with figures is described in detail below.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic exploded view of a micro air vehicle according to the present invention;

FIG. 2 is a schematic combined view of a micro air vehicle according to the present invention;

FIG. 3 is a schematic view of an angle controller of the micro air vehicle according to the present invention;

FIG. 4 is a schematic view of a first actuation of the micro air vehicle according to the present invention;

FIG. 5 is a schematic view of a second actuation of the micro air vehicle according to the present invention;

FIG. 6 is a schematic view of an angle controller according to another embodiment of the present invention;

FIG. 7A is a schematic view of a micro air vehicle according to another embodiment of the present invention;

FIG. 7B a schematic view of a first actuation of the micro air vehicle of FIG. 7A;

FIG. 7C a schematic view of a second actuation of the micro air vehicle of FIG. 7A;

FIG. 8A is a schematic view of a micro air vehicle according to still another embodiment of the present invention;

FIG. 8B a schematic view of a first actuation of the micro air vehicle of FIG. 8A;

FIG. 8C a schematic view of a second actuation of the micro air vehicle of FIG. 8A;

FIG. 9A is a schematic view of a micro air vehicle according to yet another embodiment of the present invention;

FIG. 9B a schematic view of a first actuation of the micro air vehicle of FIG. 9A; and

FIG. 9C a schematic view of a second actuation of the micro air vehicle of FIG. 9A.

### DETAILED DESCRIPTION OF THE INVENTION

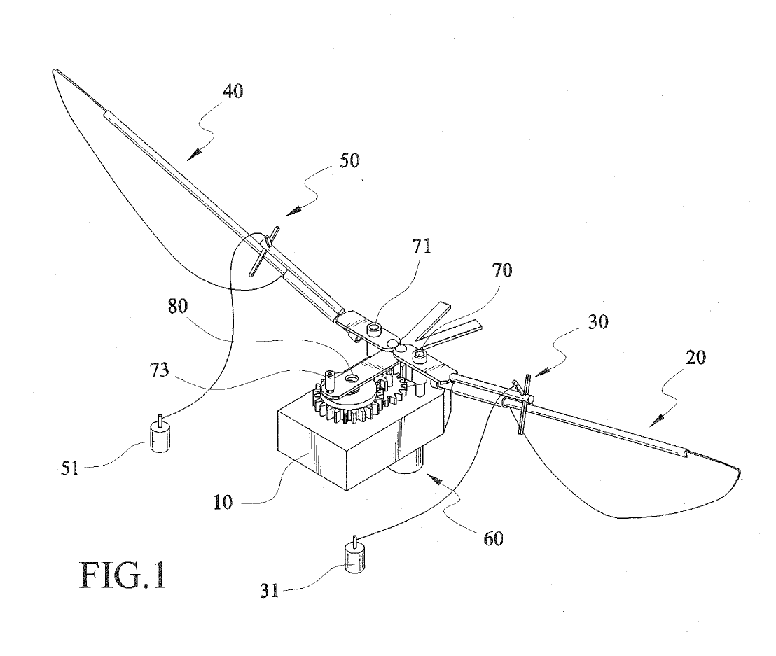

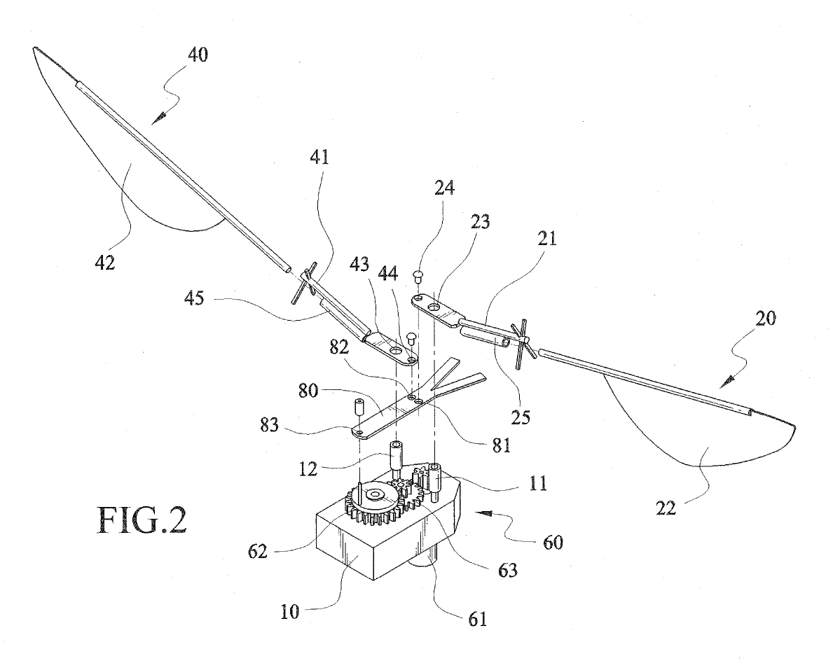

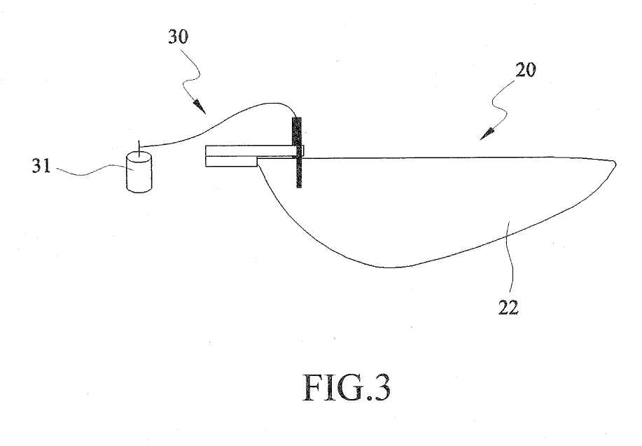

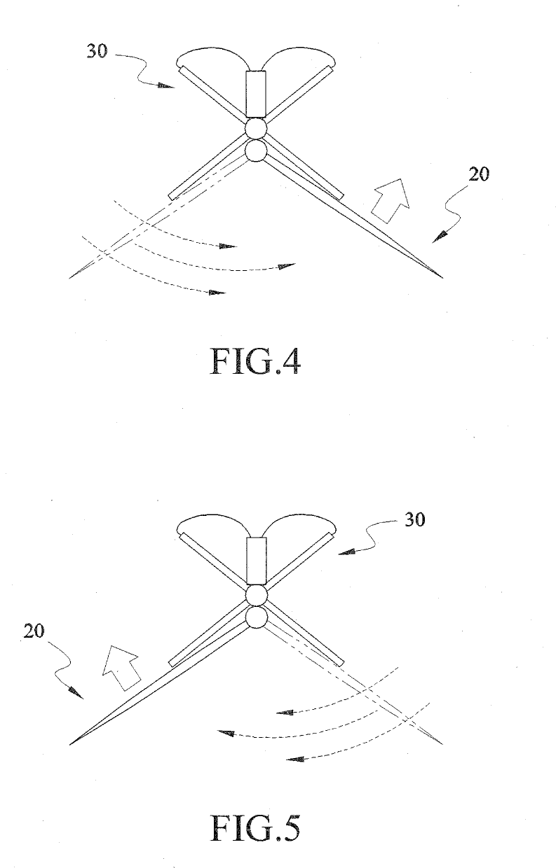

Referring to FIGS. 1-5, main components, structural features, and actuation modes of the micro air vehicle are illustrated before describing the flying wing rotation mechanism of a micro air vehicle according to the disclosure of the present invention.

The micro air vehicle of the preferred embodiment of the present invention mainly includes a body 10, a first flying wing set 20, a first angle controller 30, a second wing set 40, a second angle controller 50, a detent member 80, and a power module 60. A right shaft 11 and a left shaft 12 are arranged on the body 11. The first flying wing set 20 is disposed on the right of the body 10, and mainly includes a first flapping arm 21 and a first flying wing 22. A first through hole 23 and a first locking hole 24 are opened in an end of the first flapping arm 21. The bottom of the first flapping arm 21 extends to form a long cylinder 25. The first flying wing 22 is pivoted to the first flapping arm 21 through the long cylinder 25. The right shaft 11 passes through the first through hole 23. The first flying wing 22 is pivoted to the first flapping arm 21 through the long cylinder 25. Thus, the first flying wing 22 can rotate relative to the first flapping arm 21.

The second flying wing set 40 is disposed on the left of the body 10, and is symmetric to the first flying wing set 20. The components and the actuation relationship between the components of the second flying wing set 40 are the same as those of the first flying wing set 20. The second flying wing set 40 mainly includes a second flapping arm 41 and a second flying wing 42. A second through hole 43 and a second locking hole 44 are opened in an end of the second flapping arm 41. The bottom of the second flapping arm 41 extends to form a long cylinder 45. The left shaft 12 passes through the second through hole 43. The second flying wing 42 is pivoted to the second flapping arm 41 through the long cylinder 45. Thus, the second flying wing 42 can rotate relative to the second flapping arm 41.

A power module 60 is disposed on the body 10. The power module 60 includes a driving gear 62, a motor 61 disposed at the bottom of the body 10, and a power gear 63 disposed between and engaged with the driving gear 62 and the power motor 61. Thus, the power motor 61 can drive the driving gear 62 to rotate.

A first round hole 81 and a second round hole 82 are drilled in a front end of a detent member 80, and a bore 83 is arranged in a rear end of the detent member 80. A fixing member 70 passes through the first locking hole 24 of the first flying wing set 20, and is locked in the first round hole 81, such that the first flying wing set 20 is connected to the detent member 80. Similarly, a fixing member 71 passes through the second locking hole 44 of the second flying wing set 40, and is locked in the second round hole 82 of the detent member 80, such that the second flying wing set 20 is connected to the detent member 80. A fixing member 73 passes through the bore 83, such that the rear end of the detent member 80 is connected with the shafts on the driving gear 62.

Thus, after the power motor 61 is started, the driving gear 62 is driven to rotate accordingly, and the detent member 80 is driven to move to and fro straightly, which further drives the first flying wing set 20 and the second flying wing set 40 to flap to and fro relative to the body 10 around the right shaft 11 and the left shaft 12 respectively, so as to realize the flying motion similar to an insect flapping the thin wings.

The connection between the components of the first and the second flying wing sets 20 and 40 is described below in more detail. In the flying wing rotation mechanism of a micro air vehicle of the present invention, the first flying wing set 20 and the second flying wing set 40 are symmetric and have the same structure, so the first flying wing set 20 is taken as an example below. As the first flying wing 22 of the micro air vehicle is pivoted to the long cylinder 25 at the bottom of the first flapping arm 21, when the first flapping arm 21 swings, the first flying wing 22 will swing with the first flapping arm 21 in sync. When the first flapping arm 21 is driven by the detent member 80 to change the swing direction, the first flying wing 22 is driven under the effect of inertia and the follow-up airflows to rotate relative to the axial direction of the first flapping arm 21.

The flying wing rotation mechanism of a micro air vehicle of the present invention includes two angle controllers. A first angle controller 30 and a second angle controller 50 in the present invention are mounted on the first flapping arm 21 of the first flying wing set 20 and the second flapping arm 41 of the second flying wing set 40, respectively. The two angle controllers have the same functions, so the first angle controller 30 is taken as an example in the following illustration. The first angle controller 30 is formed by two slats disposed in cross. The deploy angles of the two slats are controlled by a first servo motor 31, so as to confine the angle of the first flying wing 22 rotating relative to the axial direction of the first flapping arm 21. When the first flapping arm 21 and the second flapping arm 41 change the swing angles, due to the effect of inertia and the generated follow-up airflows, the first flying wing 22 and the second flying wing 42 will rotate relative to the first flapping arm 21 and the second flapping arm 41, respectively. The ranges of the angles of the first flying wing 22 and the second flying wing 42 rotating relative to the first flapping arm 21 and the second flapping arm 41 are limited by the deploy angles of the first and the second angle controllers 30 and 50. Thus, when the first flapping arm 21 and the second flapping arm 41 change the swing directions, the first flying wing 22 and the second flying wing 42 will rotate relative to the first flapping arm 21 and the second flapping arm 41 respectively, so as to provide the maximum lift to the micro air vehicle.

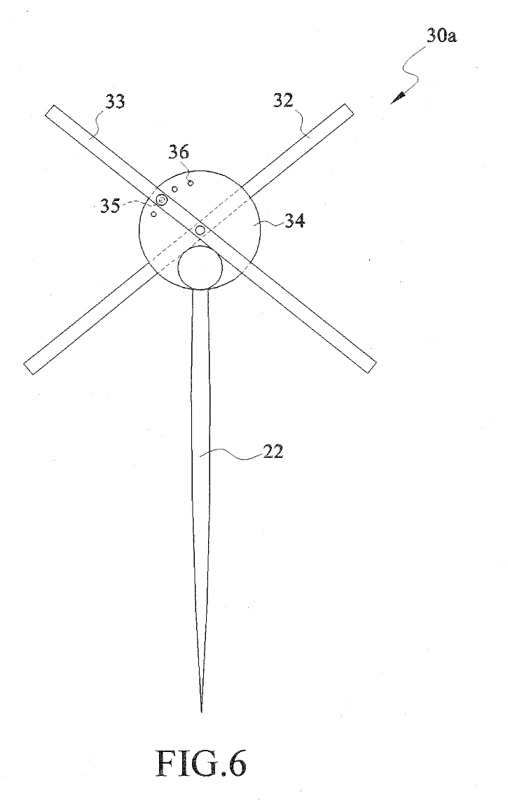

In addition to being controlled by the first and the second servo motors 31 and 51, the deploy angles of the angle controllers 30 and 50 can also be controlled manually. FIGS. 1 and 6 are schematic views of an angle controller according to another embodiment of the present invention. Taking a first angle controller 30a as an example, the first angle controller 30a is formed by two slats 32 and 33 disposed in cross, which, as shown in FIG. 6, are pivoted in front and rear. In this embodiment, the first angle controller 30a further includes a stopper tray 34 and a positioning pin 35. A plurality of positioning holes 36 is arranged in the stopper tray 34 sequentially. The stopper tray 34 is disposed on the slat 32 in the rear, and is fixed on the first flapping arm 21 together with the slat 32 in the rear. The slat 33 in the front is pivoted on the stopper tray 34, and can rotate relative to the stopper tray 34. By passing the positioning pin 35 through the slat 33 in the front to be inserted into and fixed to different positioning holes 36, the deploy angles of the two slats 32 and 33 can be changed, so as to provide a plurality of different ranges of angle of the first flying wing 22.

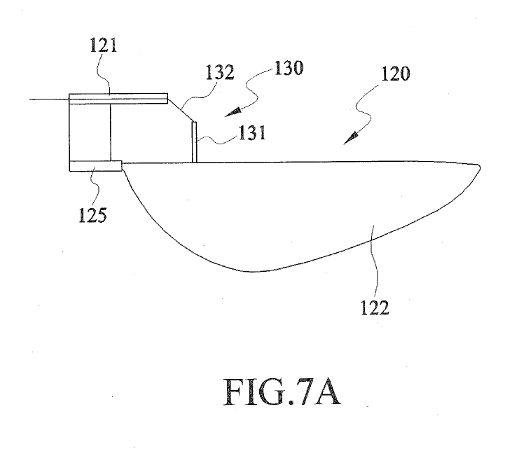

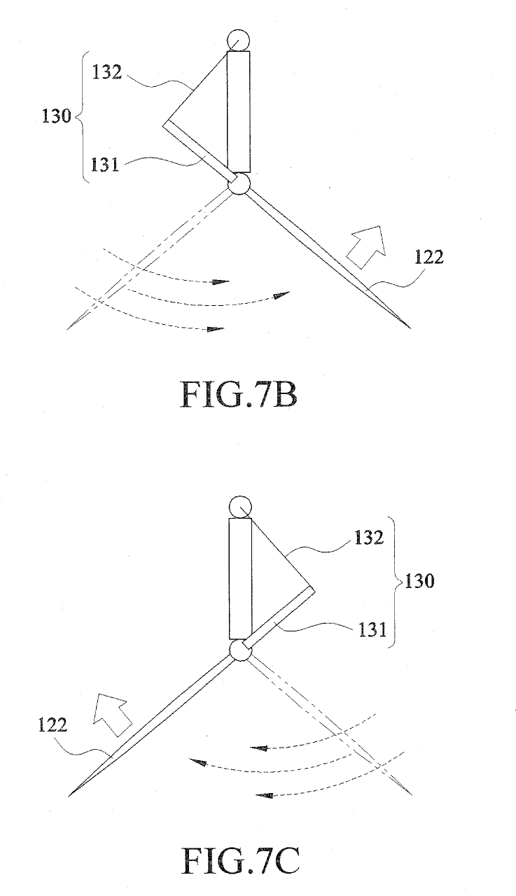

Then, referring to FIGS. 7A-7C, in a first flying wing set 120 of the micro air vehicle of another embodiment of the present invention, the bottom of a first flapping arm 121 extends to form an extending slat 127 and a long cylinder 125. Similarly, the first flying wing 122 is pivoted to the long cylinder 125, and the first flying wing set 120 includes an angle controller 130. The angle controller 130 includes a supporting rod 131 and a first fixing segment 132. The supporting rod 131 is fixed to the first flying wing 122, and two ends of the first fixing segment 132 are disposed on the first flapping arm 121 and the supporting rod 131 respectively. Therefore, when the first flapping arm 121 is driven by the detent member to change a swing direction, the first flying wing 122 will be driven under the effect of inertia and the follow-up airflows to rotate relative to the axial direction of the first flapping arm 121. The rotation angle is limited by the length of the first fixing segment 132, so as to realize the effect of angle control, as shown in FIGS. 7B and 7C.

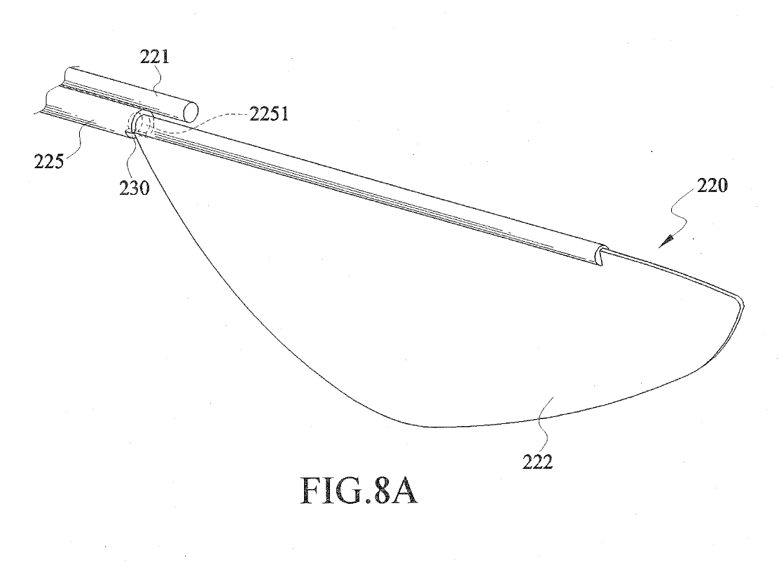

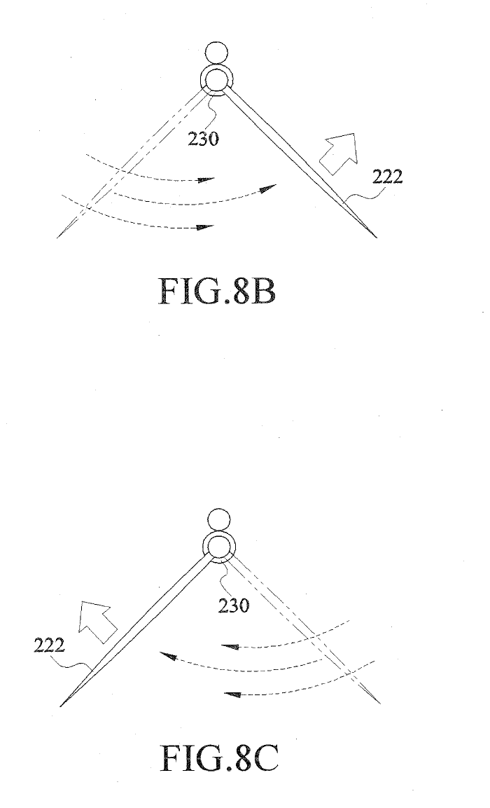

Next, referring to FIGS. 8A-8C, in a first flying wing set 220 of the micro air vehicle according to still another embodiment of the present invention, the bottom of the first flapping arm 221 extends to form a long cylinder 225. Similarly, the first flying wing 222 is pivoted to long cylinder 225. The main difference between this embodiment and the above embodiments is that in this embodiment, a sector-shaped depressed portion 230 is formed in an opening 2251 of the long cylinder 225. Therefore, when the first flying wing 222 is pivoted to the long cylinder 225, the angle of the first flying wing 222 rotating relative to the axial direction of the first flapping arm 221 is limited by the shape of the sector-shaped depressed portion 230. If the area of the sector of the sector-shaped depressed portion 230 is large, the rotation angle of the first flying wing 222 is great. If the area of the sector of the sector-shaped depressed portion 230 is small, the rotation angle of the first flying wing 222 is small. Thus, the sector-shaped depressed portion 230 in the opening 2251 of the long cylinder 225 forms an angle limiting mechanism, i.e., when the first flapping arm 221 is driven by the detent member to change the swing direction, the first flying wing 222 is driven under the effect of inertia and the follow-up airflows to rotate relative to the axial direction of the first flapping arm 221. The rotation angle is limited by the sector-shaped depressed portion 230, so as to realize the effect of angle control, as shown in FIGS. 8B and 8C.

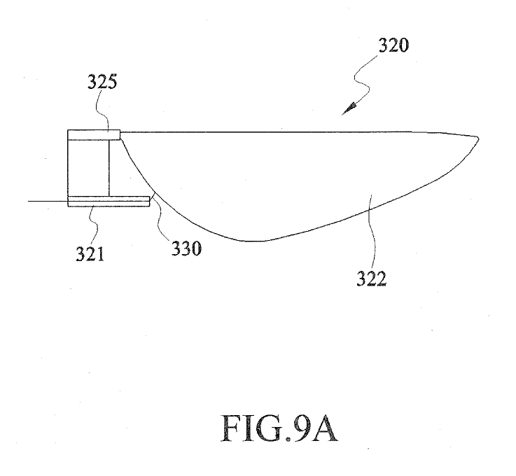

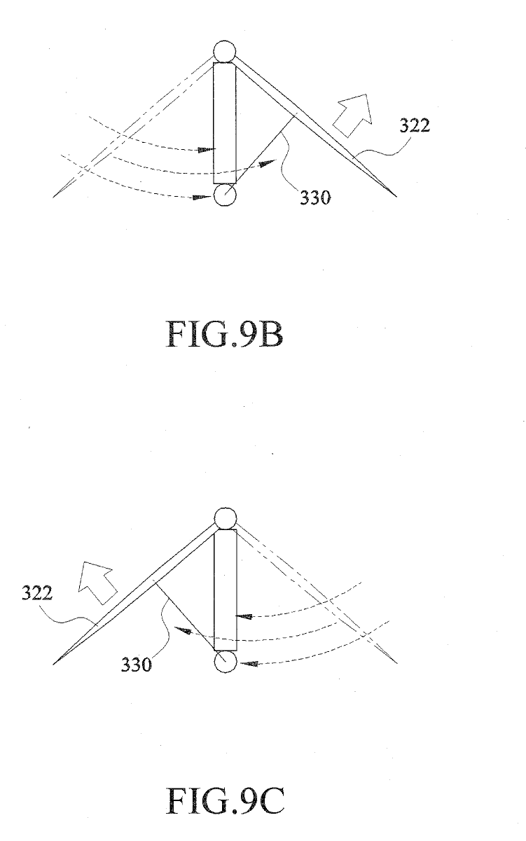

Then, referring to FIGS. 9A-9C, in a first flying wing set 320 of the micro air vehicle according to yet another embodiment of the present invention, the bottom of a first flapping arm 321 extends to form a long cylinder 325. Similarly, the first flying wing 322 is pivoted to the long cylinder 325, and the first flying wing set 320 includes an angle controller 330. The angle controller 330 is a second fixing segment, and two ends of the second fixing segment are disposed on the first flapping arm 321 and the first flying wing 322, respectively. Therefore, when the first flapping arm 321 is driven by the detent member to change a swing direction, the first flying wing 322 will be driven under the effect of inertia and the follow-up airflows to rotate relative to the axial direction of the first flapping arm 321. The rotation angle is limited by the length of the second fixing segment, so as to realize the angle control, as shown in FIGS. 9B and 9C.

The above description is the preferred embodiments of the present invention, but is not intended to limit the scope of implementation of the present invention. All equivalent variations and modifications according to the claims of the present invention shall be covered by the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A flying wing rotation mechanism of a micro air vehicle, driven under a control of a power module and a detent member, the flying wing rotation mechanism of a micro air vehicle comprising:
a flapping arm, connected to the detent member, and swinging as the power module drives the detent member; and
a flying wing, having an end pivoted to the flapping arm, when the flapping arm swings, the flying wing swinging with the flapping arm in sync, and when a swing direction of the flapping arm changes, the flying wing rotating relative to an axial direction of the flapping arm.

2. The flying wing rotation mechanism of a micro air vehicle as claimed in claim 1, wherein one side of the flapping arm extends to form a long cylinder, and the flying wing is pivoted to the flapping arm through the long cylinder.

3. The flying wing rotation mechanism of a micro air vehicle as claimed in claim 2, further comprising an angle controller disposed on the flapping arm, for confining an angle of the flying wing rotating relative to the axial direction of the flapping arm.

4. The flying wing rotation mechanism of a micro air vehicle as claimed in claim 3, wherein the angle controller comprises two slats disposed in cross.

5. The flying wing rotation mechanism of a micro air vehicle as claimed in claim 4, wherein the angle controller is equipped with a servo motor to control a deploy angle of the slats.

6. The flying wing rotation mechanism of a micro air vehicle as claimed in claim 4, wherein the angle controller further comprises a stopper tray and a positioning pin; the stopper tray is disposed between the slats, fixed to one of the slats, and movably pivoted to the other slat; a plurality of positioning holes is arranged in the stopper tray; the positioning pin passes through the other slat, and the positioning pin is inserted and fixed in one of the positioning holes.

7. The flying wing rotation mechanism of a micro air vehicle as claimed in claim 2, further comprising an angle controller having a supporting rod and a first fixing segment, wherein the supporting rod is fixed to the flying wing, and two ends of the first fixing segment are connected to the supporting rod and the flapping arm respectively.

8. The flying wing rotation mechanism of a micro air vehicle as claimed in claim 2, further comprising an angle controller having a second fixing segment connected to the flapping arm and the flying wing respectively.

9. The flying wing rotation mechanism of a micro air vehicle as claimed in claim 2, wherein an opening of the long cylinder forms a sector-shaped depressed portion, and the sector-shaped depressed portion is used to confine the angle of the flying wing rotating relative to the axial direction of the flapping arm.
